(19) United States
(12) Patent Application Publication
(10) Pub. No.: US 2005/0141692 A1
(43) Pub. Date: Jun. 30, 2005

(54) Computer-telephony integration (CTI) system for controlling an automatic call distribution system using a bidirectional CTI model

(76) Inventors: Mark Scherer, Centennial, CO (US); Ken Martin, Littleton, CO (US)

Correspondence Address: JENNIFER L. BALES, MOUNTAIN VIEW PLAZA, 1520 EUCLID CIRCLE, LAFAYETTE, CO, 80026-1250, US

(21) Appl. No.: 10/955,595

(22) Filed: Sep. 30, 2004

Related U.S. Application Data
(60) Provisional application No. 60/507,628, filed on Oct. 1, 2003.

(51) Int. Cl. H04M 3/00; H04M 5/00

(52) U.S. Cl. 379/265.02

(57) ABSTRACT

A Computer-Telephony Integration (CTI) system is used to control an Automatic Call Distribution (ACD) system, and non-ACD phone functions, where all functions can be performed at either the phone or the computer display by creating a Bidirectional CTI Model (BCM) in software. The ACD system is used in call centers to route incoming calls to call takers according to attributes such as dispatcher skill-sets or time since last call received. The ACD system is also able to send a call to a dispatcher without ringing, using an auto-answer system. The CTI system allows telephone functions such as originating calls, answering calls, and hold, transfer, and conference features to be controlled by a computer workstation.

This application claims priority from Provisional Patent Application Ser. No. 60/507,628, filed Oct. 1, 2003.

### BACKGROUND OF THE INVENTION

1. Field of the Invention

The present invention relates to apparatus and methods for controlling an Automatic Call Distribution (ACD) system. In particular, the present invention relates to a Computer-Telephony Integration (CTI) system for controlling an ACD system wherein all functions can be performed at a telephone or a computer display.

2. Description of the Prior Art

FIG. 1A (Prior Art) shows a conventional Automatic Call Distribution (ACD) system. ACD systems are used to control the routing of phone calls to call takers. An incoming call 100 is routed by a phone company's Central Office (CO 101) to a privately owned phone switch 103 in a call center. The ACD software 104 is programmed to automatically route incoming calls 100 to call takers 109, based on a number of attributes such as type of call, ability of each call taker, how long the call has been ringing, and how many calls each call taker has taken. These systems are commonly used by customer support organizations that need to handle large numbers of incoming calls from customers.

Typical Call Centers function to handle large numbers of incoming calls arriving over a large number of trunk lines 102, and distributing them to a common pool of call takers. These call centers use ACD software to handle all incoming calls, and allow computerized control of call routing, distribution, and answering. They are designed to handle incoming calls only.

FIG. 1B (Prior Art) shows a conventional Computer Telephony Integration system (CTI). CTIs are used to control phone functions from a computer workstation 107. The computer workstation is able to control various phone operations by sending messages to either a stand-alone CTI capable phone set 109 directly connected to a Private phone switch 103, or by sending messages to software running Switch CTI Services 105 that communicated with the private switch. Typical functions offered by CTI systems are Answer Call, Originate call, Put call on-hold, transfer a call, or create a call conference. The CTI systems increase productivity for receptionists that handle both incoming and outgoing calls, from many different locations.

FIG. 1C (Prior Art) shows a conventional Public Safety Answering Points (PSAP) phone center. PSAPs are government run phone centers that answer large numbers of emergency 9-1-1 telephone calls for a particular area. A 911 Emergency phone call 100 is routed by the telephone company's Central Office Switch 101 via a 911 Trunk line 102 to a Private phone switch 103 that the PSAP owns. PSAPs commonly also answer incoming non-emergency lines for the police and fire departments which arrive on normal trunk lines. The 911 Trunk lines also send Automatic Number Identification (ANI 111), which is decoded by a computer often called an ALI Controller 112. The ALI controller sends the ANI information over a modem to an Automatic Location Identification (ALI) service 110, which returns the address information over the same modem line. This information is displayed 108 to the call takers as soon as they answer a call.

PSAP function can be enhanced by an ACD system. However, PSAPs have several unique requirements that are not met by current ACD systems. Among these functions are the ability to display phone number and address information before a call is answered, the ability to immediately call back any calls that were abandoned by the caller before being answered; the ability to dispatch calls to other, more appropriate jurisdictions, such as neighboring PSAPs, fire departments, and police departments by communication with the CO switch 101 via the special 911 Trunk lines 102, and the ability to transfer information relating to a call (such as the ANI and ALI) to other agencies receiving a call or acting upon a call. Not all of these other functions can be handled by current CTI systems.

A need remains to integrate all ACD features with CTI features along with additional features specific for PSAP needs.

### SUMMARY OF THE INVENTION

It is an object of the present invention to provide apparatus and methods for controlling an Automatic Call Distribution (ACD) system, and non-ACD phone functions on a common Computer-Telephony Integration (CTI) system where all functions can be performed at either the phone or the computer display by creating a Bidirectional CTI Model (BCM) in software. The ACD system is used in call centers to route incoming calls to Call takers according to attributes such as dispatcher skill-sets or time since last call received. The ACD system is also able to send a call to a dispatcher without ringing, using an auto-answer system. The CTI system allows telephone functions such as originating calls, answering calls, and hold, transfer, and conference features to be controlled by a computer workstation instead of the phone.

The BCM system of the present invention creates an internal model of the state of the Telephone switch, the ACD system, and the state of each phone to enable a computer display to control and display all features of an ACD system and a CTI system. By modeling the state of each phone set, it allows all functions to be accomplished by using the phone set or the computer display. Any action taking place on the phone set updates the BCM, and show on the display. Conversely, any telephony action taken on the computer display sends messages to the phone switch, which updates the phone set. Thus the call dispatcher can freely use and switch back and forth between either the computer display or the phone set to accomplish phone functions. The BCM system also uses a unique directory number for each trunk to allow individual trunk monitoring of all calls. This allows the BCM to display the phone number and address information of a 9-1-1 emergency call to all call takers and supervisors well before the calls are answered. It also allows management of the CTI on either a trunk basis or a phone set basis.

The present invention coordinates all information about the states of incoming 9-1-1 emergency, and non-emergency trunks, the ANI and ALI of the incoming trunks, private phone switch, an array of digital phone sets connected to the switch, an ACD system, and a CTI system. The heart of the system uses a Bidirectional CTI model (BCM), which models of all these components. This model allows all functions to be integrated, and controlled from either a computer workstation or a phone set. It also allows for real-time presentation of the status of the phone system and all calls to be displayed to both call takers and supervisors.

More generally, the present invention includes apparatus and methods for distributing incoming telephone calls to a plurality of telephones having associated workstations comprising an automatic call distribution (ACD) system module for assigning incoming calls to telephones, a computer-telephone integration (CTI) system for allowing telephone functions to be performed at workstations, and a bidirectional CTI modeling (BCM) module for monitoring the state of each telephone call, telephone, and workstation, wherein the model is updated immediately after each telephone function is performed by a telephone or workstation, such that all telephone functions may be performed at either the telephones or the workstations in any sequence.

When the invention is used in a PSAP environment, it further includes an automatic location information (ALI) module for using automatic number identification (ANI) from 911 telephone calls to determine address information and providing the address information to the telephones and workstations. The telephone functions performed by the telephones and the workstations include answering, holding, and transferring calls. A feature is the ability to provide address information at telephones and workstations prior to the telephone call being answered. Another feature is displaying the status of all telephone calls.

The BCM includes a quicklink module including an agent model for keeping track of whether telephones are ready or busy, a trunk model for keeping track of trunk numbers and types, a call model for keeping track of call type, call trunk, and the telephone answering the call, and a phone set model for keeping track of call ID, call state and call type. It also includes a CTI interface module comprising a phone decode block for decoding input from telephones and an encode CTI block for encoding input from workstations for transfer to the associated telephones.

The invention includes an ACD interface module comprising an ACD decode block for decoding input from the ACD and providing it to the BCM and an ACD encode block for encoding output from the BCM and providing it to the ACD. The input and output include login and logout of telephones, whether telephones are busy, and routing information.

### BRIEF DESCRIPTION OF THE DRAWINGS

FIG. 1A (Prior Art) shows a conventional Automatic Call Distribution (ACD) system.

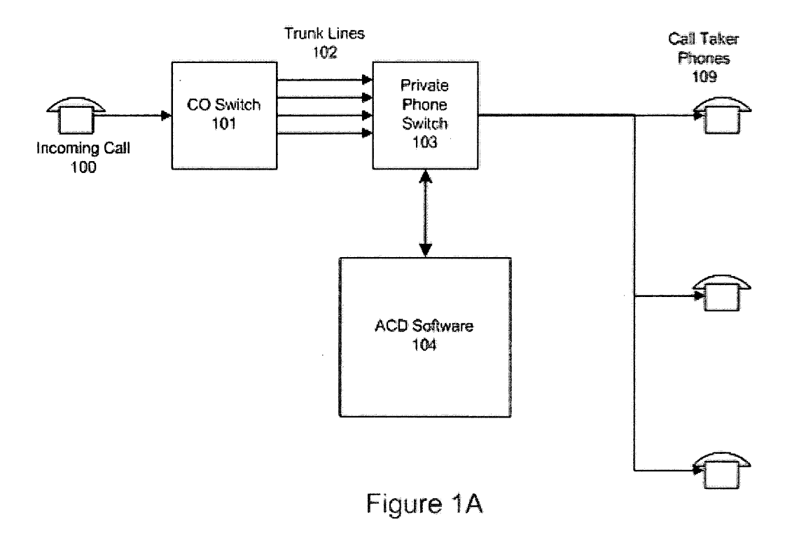

FIG. 1B (Prior Art) shows a conventional Computer Telephony Integration system (CTI).

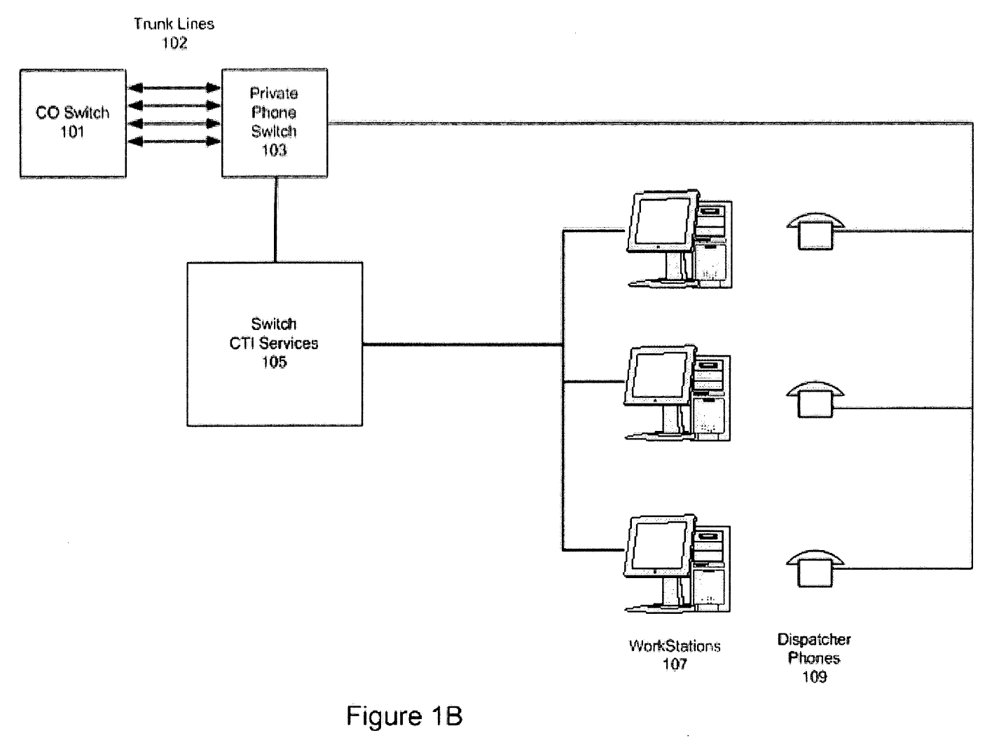

FIG. 1C (Prior Art) shows a conventional Public Safety Answering Points (PSAP) phone center.

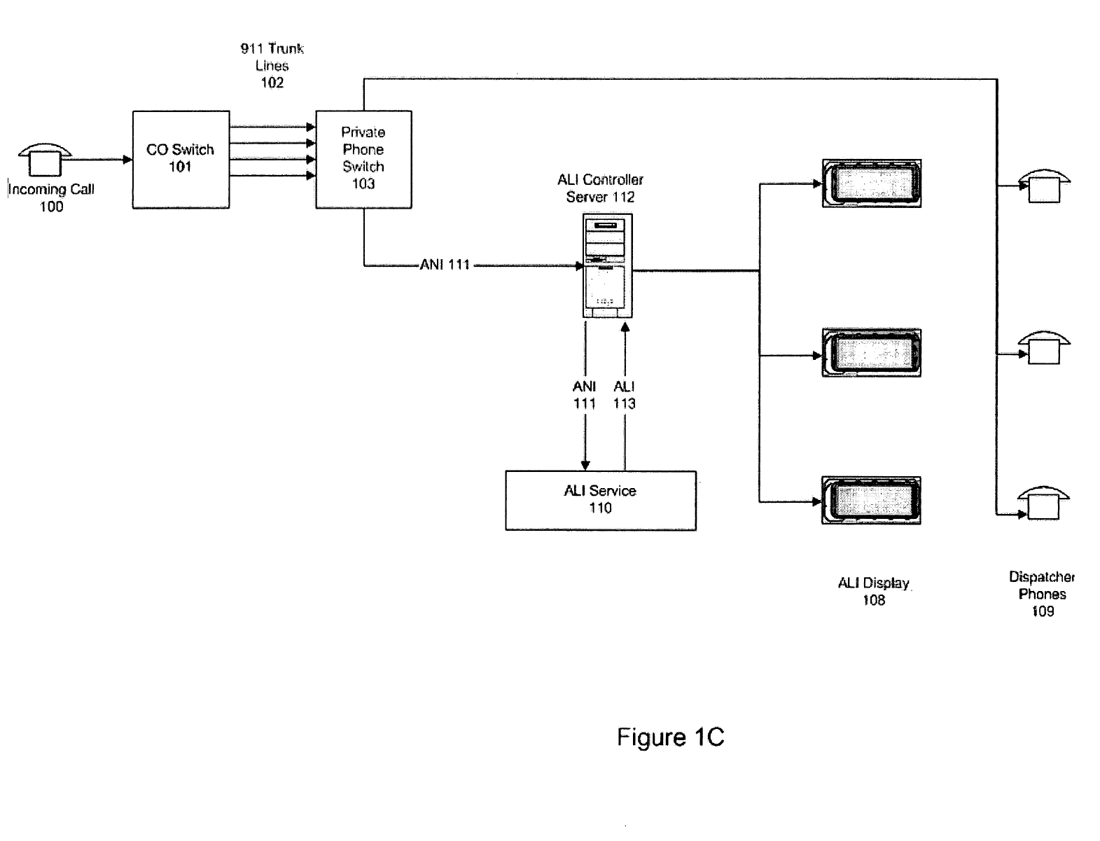

FIG. 2A is a block diagram showing an overview of a preferred embodiment of the present Computer-Telephony Integration (CTI) system for controlling an Automatic Call Distribution (ACD) system by creating a Bidirectional CTI Model (BCM).

FIG. 2B is a block diagram showing the BCM of FIG. 2A in more detail.

FIG. 3 is a block diagram showing the ACD interface of FIG. 2B in more detail.

FIG. 4 is a block diagram showing the Bidirectional CTI Models and Processes of FIG. 2B in more detail.

FIG. 5 is a block diagram showing the Quicklink, ALI Controller and Workstation Software of FIG. 2B in more detail.

FIG. 6 is a flow diagram illustrating a time line example of a the process involved in processing a 911 call according to the present invention.

### DETAILED DESCRIPTION OF THE PREFERRED EMBODIMENTS

Abbreviations in the Specification

| | |
|---|---|
| ACD | Automatic Call Distribution |
| ALI | Automatic Location Information |
| ANI | Automatic Number Identification |
| BCM | Bidirectional CTI Module |
| CTI | Computer-Telephone Integration |
| CO | Central Office |
| DN | Directory Number |
| PSAP | Public Safety Answering Point |
| TCP/IP | Transmission Control Protocol/ |
| | Internet Protocol |
| TDN | Trunk Directory Number |

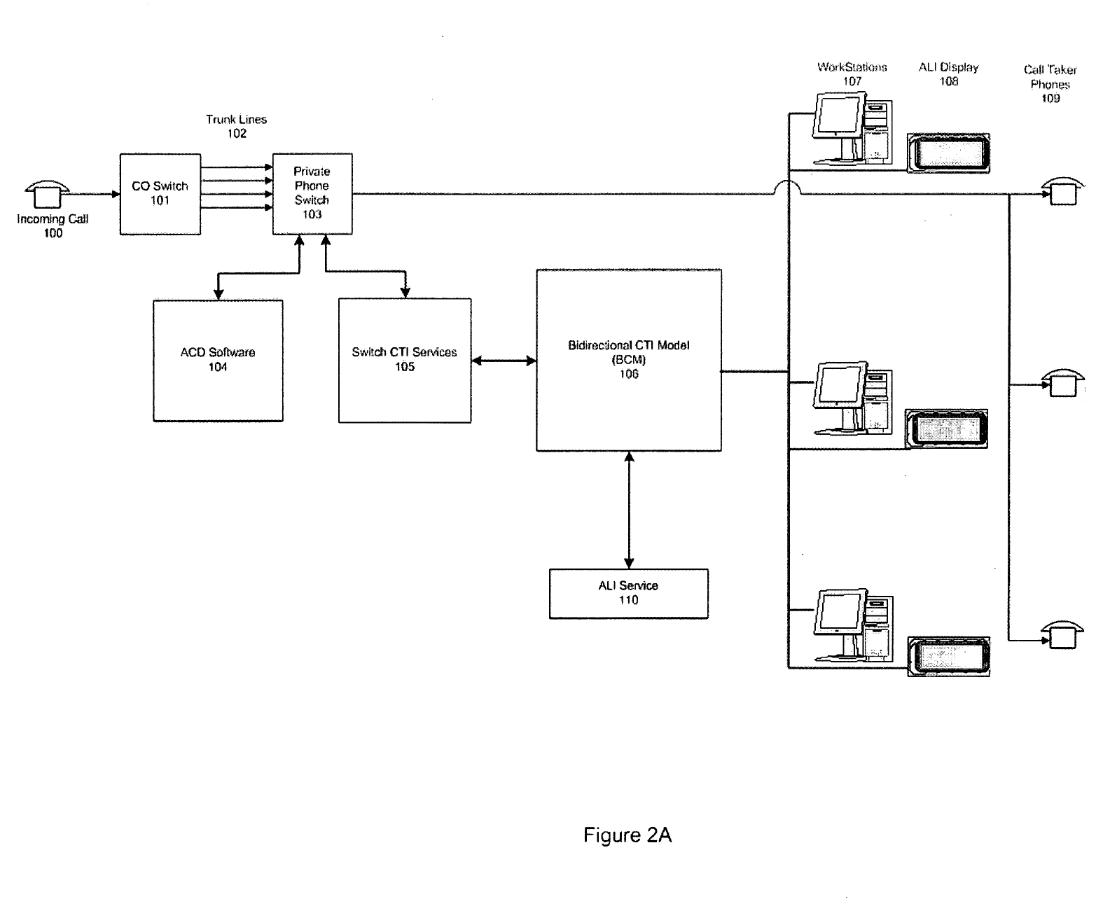

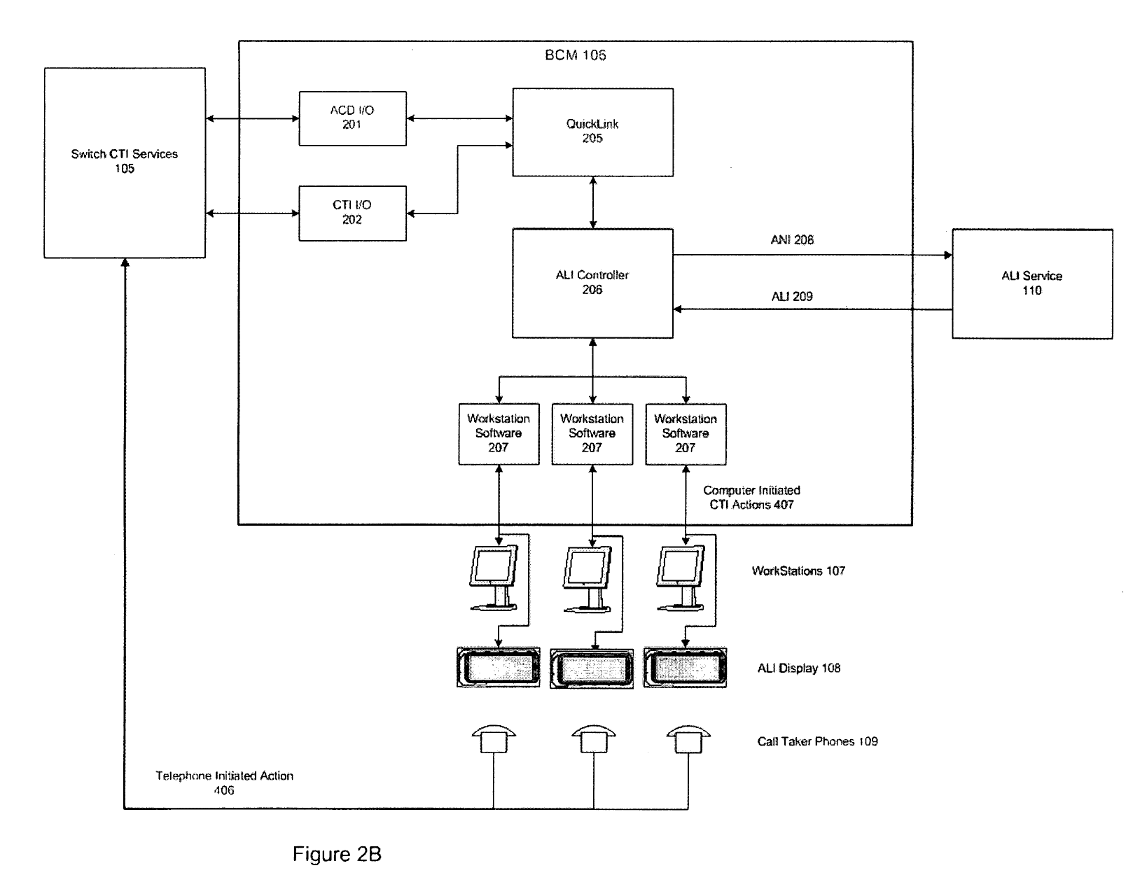

FIG. 2A is a block diagram showing a preferred embodiment of the present Computer-Telephony Integration (CTI) system for controlling an Automatic Call Distribution (ACD) system by creating a Bidirectional CTI Model (BCM). Incoming phone trunks 102 can be divided into groups for custom treatment by an ACD system 104. These are referenced by a Trunk Directory Number (TDN). For example, on the Nortel Meridian switch ACD system, these groups are called Controlled Directory Numbers (CDN). The BCM system assigns a separate TDN to each trunk 501 so the current status of every trunk can be shown on the computer workstation. All information arriving with the incoming call (ALI and ANI for emergency 9-1-1 trunks, Caller ID information for standard trunks) is stored by the BCM and associated with the trunk/CDN association. The BCM coordinates and communicates with the Switch CTI Services 105, with the Computer workstations responsible for CTI 107, with the ALI display 108, and indirectly with the ACD software 104 via the switch CTI services.

Multiple Phone Sets 109 are connected to the phone switch. Each phone set has multiple, functionally independent Directory Numbers (DNs). A DN can be either assigned to the ACD system to take incoming ACD calls, or assigned a non ACD DN extension number that can be used to make outgoing calls, and direct to extension incoming calls and intercom calls from other call taker positions. The ACD system communicates directly with the phone sets, as does the CTI interface.

FIG. 2B is a block diagram showing the BCM of FIG. 2A in more detail. The BCM is subdivided into 5 systems as shown in FIG. 2B. A QuickLink Module 205 communicates with Switch CTI services 105 using TCP/IP or serial communication. The CTI services are in communication with the private phone switch 103 installed in the Call Center. Each CTI is usually proprietary, and tightly coupled to a particular switch model and manufacturer. For example, the Nortel Meridian series switches use Meridian Link Services to communicate with external computer software. A specific ACD I/O 201 and CTI I/O 202 modules is used to communicate between the QuickLink module and the Switch specific CTI services. This modular design allows everything to the right of these modules to be used for any type of switch.

The QuickLink software 205 keeps track of the states of each trunk, each phone call, and each phone set. It resides on a central server computer, and communicates with an ALI Controller module residing on the same or a different server.

The ALI Controller module 206 uses the ANI detected on 9-1-1 emergency phone calls, and sends a bid via signal 208 for address (ALI) information via either a dedicated modem to a phone company address database or a local 9-1-1 address database 110. The ALI Controller module stores the Address information received for each phone call and delivers it to the computer workstation of the call taker that answers the call via signal 209. The address information is also broadcast to all workstations, and displayed with the applicable trunk and call information. The ALI controller keeps a copy of the BCM model, and replicates this model back to the QuickLink Module and forward to all the Workstations 107. It can also display status information about each phone trunk, phone call, and each DN on every station. It is also sent to separate ALI Displays 108, that offer redundancy if an individual Computer workstation is rendered inoperable.

The Workstation Software module 207 exists on a separate computer workstation 107 for each call taker. It provides a CTI interface for the call taker to interact with their telephone from the workstation display. It also displays status information about the current calls on the phone switch. All CTI actions are passed back to the ALI Controller, and then to the QuickLink, where they are sent to the private switch via the CTI Interface 202.

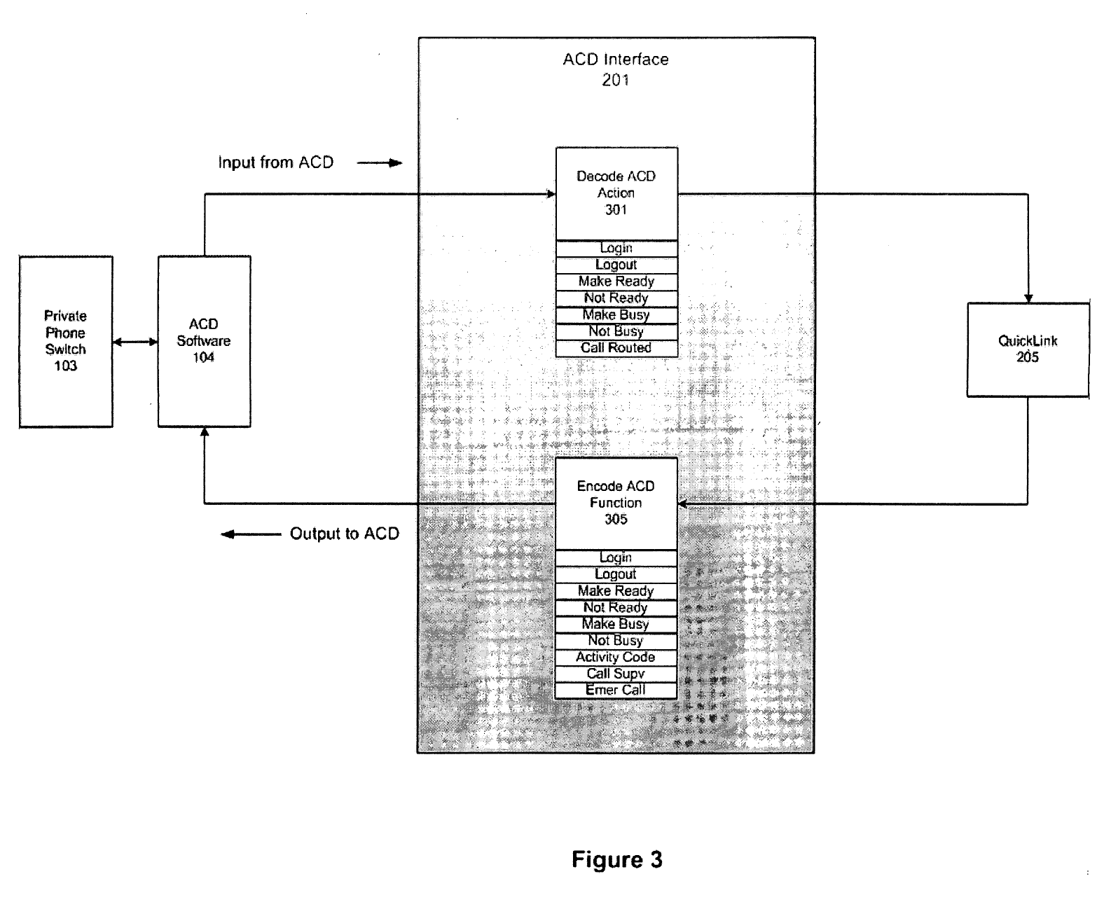

FIG. 3 is a block diagram showing the ACD interface 201 of FIG. 2B in more detail. ACD Software 104 running on the phone switch 103 or on another server routes incoming calls to phone positions. Completed ACD events are sent by the ACD software to the Switch services 105 (see FIG. 2B). The Switch CTI services sends these events to a switch specific decoder 301, which decodes them, and send them to Quicklink 205, where they update various models in the BCM. ACD events include Login/Logout of agents at a phoneset; telling the system the agent is Ready/Not Ready to take ACD calls; making a phone set Busy/Not Busy; Routing a call to a set; entering an Activity code to classify a call; calling a supervisor; and informing a supervisor of an emergency situation.

ACD routing commands (Call routed) are initiated by the ACD software 104. All other ACD commands can be initiated by the Computer Workstations 407 or from the phone set 109. Computer initiated commands get sent by Quicklink to the ACD encoder 305, where they are translated into messages that can be understood by the ACD software 104. No change is made to the models at this point. Instead, the system waits for input from the ACD. This allows actions taking place at either the phone, or the Computer to have the same effects.

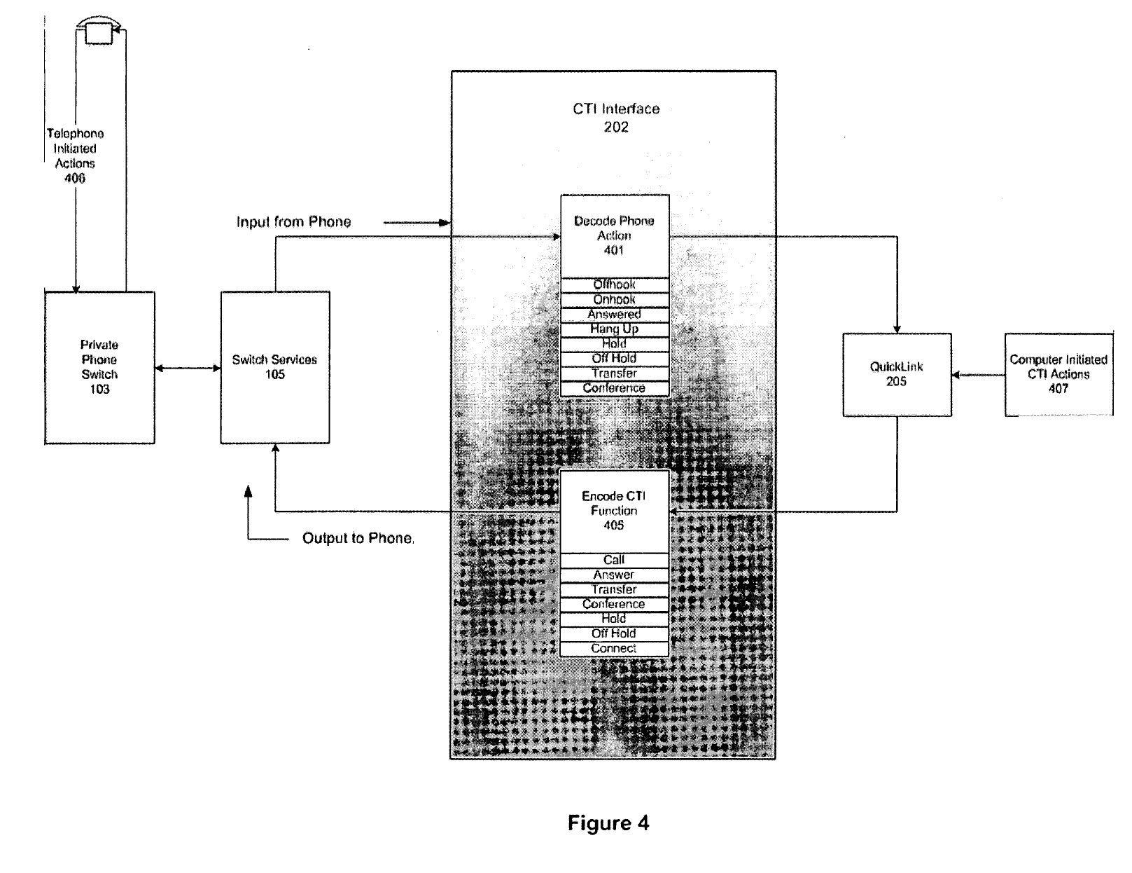

FIG. 4 is a block diagram showing the Bidirectional CTI Models and Processes 202 of FIG. 2B in more detail. CTI functions can be initiated in two ways, either from the Phone set or from Computer workstation. The computer initiated CTI actions 407 are sent to QuickLink 205, then encoded in messages 405 that are specific for the private phone switch used, and sent to the Switch services 105, where they are send to the private phone switch 103. Telephone initiated actions 406 get sent directly to the phone switch, and reported via the Switch services to the CTI interface input. This input is then decoded within the switch specific CTI interface 401 and sent to Quicklink 205.

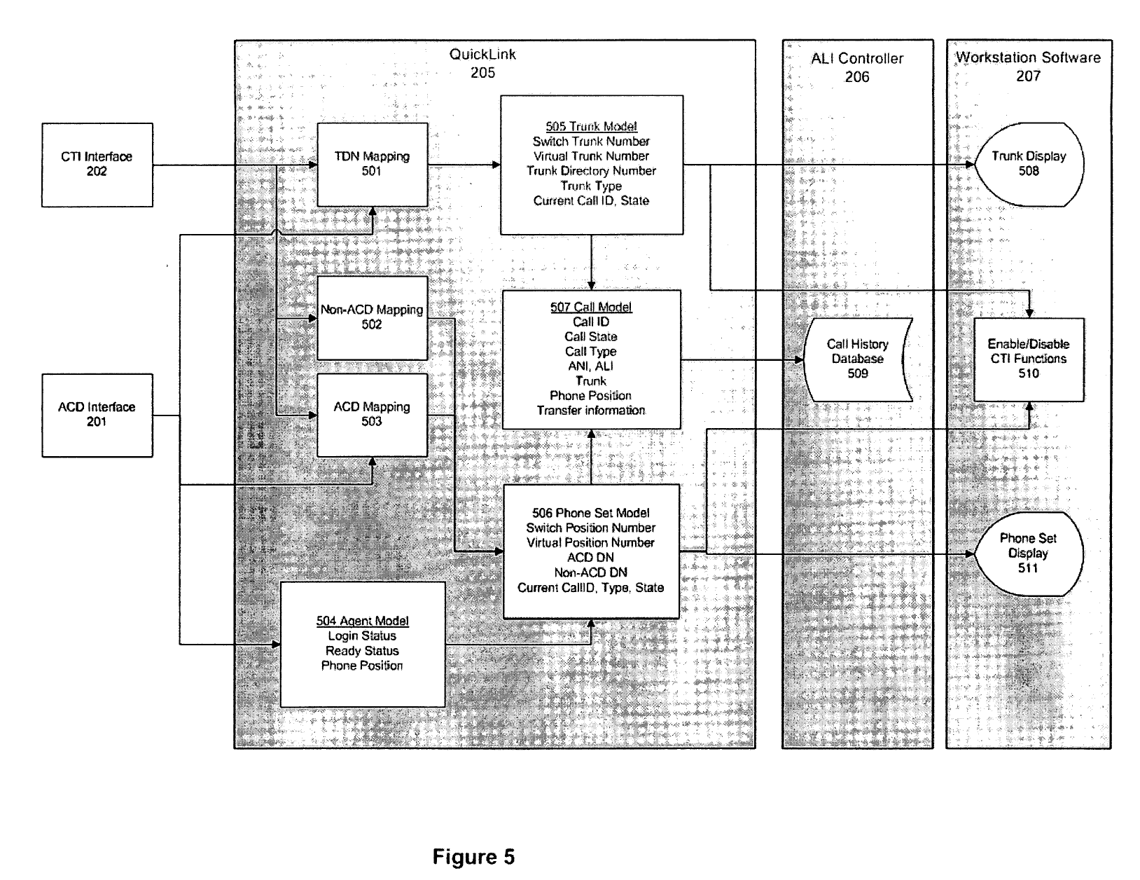

FIG. 5 is a block diagram showing the Quicklink 205, ALI Controller 206 and Workstation Software 207 in more detail. The ACD Interface 201 sends Call Taker Agent commands (e.g. Login, Logout, Make Ready, Not Ready, Make Busy, Not Busy) to the Agent Model 504. The agent model keeps track of which agent is Logged into each phoneset, and whether they are Ready to receive ACD calls, and whether the phoneset is busy, or can receive non-ACD calls. The CTI interface and the ACD interface sends all other events to the TDN mapping 501 to determine the trunk, and to either the ACD Mapping unit 503 if related to an ACD call, or the Non-ACD Mapping unit 502 for non-ACD calls. The Agent model then sends information to the appropriate Phone Set Model 506.

The TDN mapping unit translates all events to a particular Trunk in the Trunk Model 505. This Trunk model associates the trunk number known to the switch with the Virtual Trunk number used in the CTI software, and the Trunk Directory number used by the ACD. It also distinguishes between 911 and regular trunks. Phone events are processed by the trunk model to assign a state of the current trunk. This information is send via the ALI Controller software 206 to the workstation software 207 to update the trunk display 508 on each workstation, which shows the current status of every trunk. It is also used to enable and disable CTI commands associated with trunks 510. For example, the answer call function is only enabled if a call is ringing on a particular trunk. The hang up call is only available if a call is currently in progress, and has been answered by the agent running a copy of the workstations software. After the trunk model is updated, the event is sent to the Call Model 507.

The Phone Set Model 506 is created by associating each Agent with the phone set they are logged into. The phone set has a Position number known to the switch, and a different virtual position number as shown in the software. Each phone set can also handle ACD calls on an ACD directory number, and a non-ACD Directory number. When a call event occurs, information about the event is sent from the CTI interface 202 to either the ACD 503 or non-ACD 502 Mapping unit. This information is forwarded to the appropriate Phone set model 506. which is used to update the Current CallID, Call type, and Call State. This information is sent via the ALI controller 206 to the version of the Workstation Software 207 for that particular Phone. This is used to update the Phone set Display 511, and to enable and disable specific CTI functions 510. The Phone Set event information is also sent to the Call Model 507.

The Call Model 507 keeps track of every event happening on a particular call. It associates the Position that answered the call, the trunk the call came in on, the ANI, the ALI, the type of call, and where the call was transferred or conferenced to. This information is sent to the ALI controller software 206, where it is written to a Call history Database 509 when the call is completed.

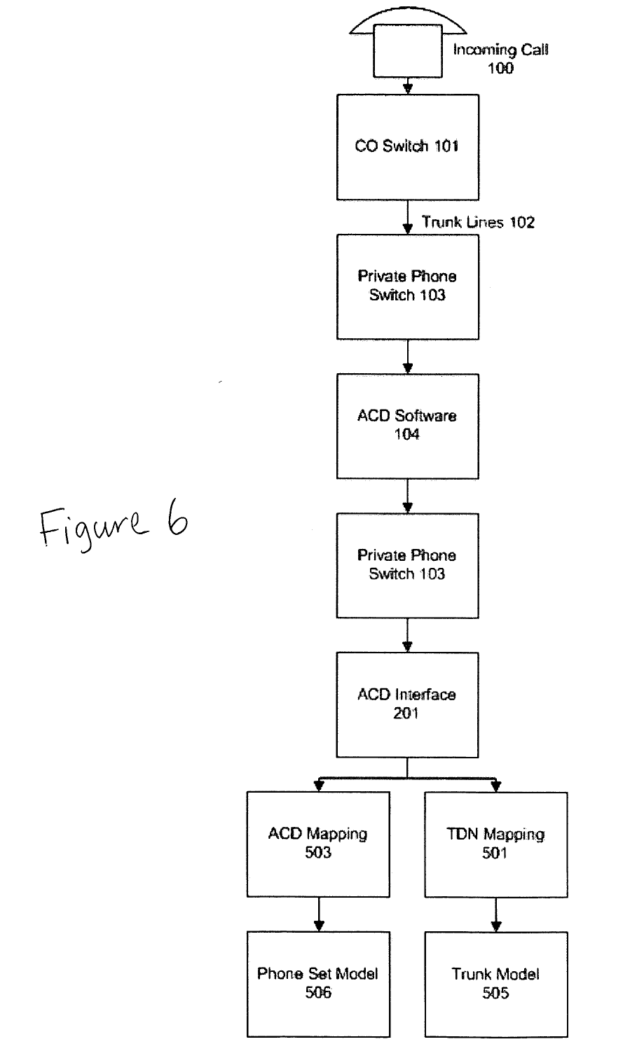

FIG. 6 is a flow diagram illustrating a time line example of the process involved in processing a 911 call according to the present invention. A 911 Call 100 is made, and arrives at the central office switch 101. The CO switch adds the ANI to the call, chooses a trunk line 102 to send the call to the appropriate PSAP. The PSAP's private phone switch 103 informs the ACD software 104 that a call has arrived. The ACD software assigns the call to a particular phone position with an active Agent, and instructs the private phone switch 103 to switch the call to the agent's telephone set. The ACD sends a message to the ACD Interface 201 of the call, and which agent it was assigned to. The ACD Interface passes this message to the ACD Mapping Unit 503 and the TDN Mapping Unit 501. These units update the Phone Set Model 506 and the Trunk Model 505.

The following tables gives examples of sets of elements monitored by each block 504, 505, 506, and 507. Additional or different elements may be used where useful.

TABLE 1

| | Trunk Model 505 |
|---|---|
| 1. | Switch Trunk Number |
| 2. | Displayed Virtual Trunk Number |
| 3. | Trunk Directory Number (TDN) |
| 4. | Trunk Type (911 or Administrative) |
| 5. | Current Call ID |
| 6. | Current Call State |

TABLE 2

| | Phone Model 506 |
|---|---|
| 1. | Switch Position Number |
| 2. | Displayed Virtual Position Number |
| 3. | ACD Directory Number |
| 4. | Non-ACD Directory Number (DN) |
| For Each Directory Number | |
| A. | Current Call ID |
| B. | Current Call State |
| C. | Current Call Type |

TABLE 3

| | Agent Model 504 |
|---|---|
| 1. | Login Status |
| 2. | Ready Status |
| 3. | Phone Position Logged into |

TABLE 4

| | Call Model 507 |
|---|---|
| 1. | Call ID |
| 2. | Call State |
| 3. | Automatic Number Identification (ANI) |
| 4. | Automatic Location Identification (ALI) |
| 5. | Trunk |
| 6. | Phone Position |
| 7. | Call Type |
| 8. | Transfer Information |

Those skilled in the art will appreciate that various modifications to the exemplary embodiments are within the scope of the patent.

1. Apparatus for distributing incoming telephone calls to a plurality of telephones having associated workstations comprising:
an automatic call distribution (ACD) system module for assigning incoming calls to telephones;
a computer-telephone integration (CTI) system for allowing telephone functions to be performed at workstations; and
a bidirectional CTI modeling (BCM) module for monitoring the state of each telephone call, telephone, and workstation, wherein the model is updated immediately after each telephone function is performed by a telephone or workstation, such that all telephone functions may be performed at either the telephones or the workstations in any sequence.

2. The apparatus of claim 1, further including an automatic location information (ALI) module for using automatic number identification (ANI) from 911 telephone calls to determine address information and providing the address information to the telephones and workstations.

3. The apparatus of claim 2 wherein the telephone functions performed by the telephones and the workstations include answering, holding, and transferring calls.

4. The apparatus of claim 2 further including means for providing address information at telephones and workstations prior to the telephone call being answered.

5. The apparatus of claim 4 further including means for displaying the status of all telephone calls.

6. The apparatus of claim 1 wherein the BCM includes a quicklink module comprising:
an agent model for keeping track of whether telephones are ready or busy;
a trunk model for keeping track of trunk numbers and types;
a call model for keeping track of call type, call trunk, and the telephone answering the call; and
a phone set model for keeping track of call ID, call state and call type.

7. The apparatus of claim 1 wherein the BCM includes a CTI interface module comprising:
a phone decode block for decoding input from telephones; and
an encode CTI block for encoding input from workstations for transfer to the associated telephones.

8. The apparatus of claim 1 wherein the apparatus includes an ACD interface module comprising:
an ACD decode block for decoding input from the ACD and providing it to the BCM; and
an ACD encode block for encoding output from the BCM and providing it to the ACD.

9. The apparatus of claim 8 wherein the input and output include login and logout of telephones, whether telephones are busy, and routing information.

10. A method of distributing incoming telephone calls to a plurality of telephones and associated workstations comprising the steps of:
a) assigning each call to a telephone and workstation;
b) monitoring the telephone and functions performed at the telephone;
c) monitoring the workstation and functions performed at the workstation;
d) generating a model of the telephone call which includes the telephone, the workstation, functions performed at the telephone, and functions performed at the workstation; and
e) updating the model after each function performed at the telephone or the workstation so that function may be performed at the telephone or the workstation in any sequence.

11. The method of claim 10 further including the steps of determining automatic number identification (ANI) from a telephone call, determining address information from the ANI, and providing address information to the telephone and the workstation.

12. The method of claim 11 wherein the step of providing address information is performed prior to the telephone call being answered.

13. The method of claim 11, further including the step of displaying status for all telephone calls.

14. An improved public safety answering point system (PSAP) for answering incoming 911 calls and distributing the calls to a plurality of telephones and associated workstations, the system comprising:
an automatic call distribution (ACD) system module for assigning incoming calls to telephones;
a computer-telephone integration (CTI) system for allowing telephone functions to be performed at workstations;
a bidirectional CTI modeling (BCM) module for monitoring the state of each telephone call, telephone, and workstation, wherein the model is updated immediately after each telephone function is performed by a telephone or workstation, such that all telephone functions may be performed at either the telephones or the workstations in any sequence; and
an automatic location information (ALI) module for using automatic number identification (ANI) from 911 telephone calls to determine address information and providing the address information to the telephones and workstations.

15. The apparatus of claim 14 further including means for providing address information at telephones and workstations prior to the telephone call being answered.

16. The apparatus of claim 15 further including means for displaying the status of all telephone calls.
